(19) United States
(12) Patent Application Publication
(10) Pub. No.: US 2024/0259892 A1
(43) Pub. Date: Aug. 1, 2024

(54) METHODS, UES, NETWORK NODE, MEDIA FOR PATH SWITCHING HANDLING WITH DIFFERENT TYPES OF CANDIDATE PATHS

(71) Applicant: Telefonaktiebolaget LM Ericsson (publ), Stockholm (SE)

(72) Inventor: Zhang ZHANG, Beijing (CN)

(21) Appl. No.: 18/564,067

(22) PCT Filed: Apr. 29, 2022
(86) PCT No.: PCT/CN2022/090267

§ 371 Date: Nov. 25, 2023

(30) Foreign Application Priority Data
May 27, 2021 (WO) PCT/CN2021/096252

(51) Int. Cl. H04W 36/00; H04W 88/04

(52) U.S. Cl. CPC H04W 36/0058; H04W 36/03; H04W 88/04

(57) ABSTRACT

Methods, UEs, a network node, and computer readable storage media for path switching handling with multiple different types of candidate paths are disclosed. The method at a first UE includes: obtaining a type of a second UE; and transmitting, to a network node, measurement report(s) of at least one second UE, wherein a measurement report of each of the at least one second UE includes an indication of a type of the second UE.

### TECHNICAL FIELD

The present disclosure relates to wireless communications, and in particular, to methods, User Equipments (UEs), a network node, and computer readable storage media for path switching handling with multiple different types of candidate paths.

### BACKGROUND

### Sidelink (SL) Transmissions in New Radio (NR)

Sidelink transmissions over NR are specified for Rel. 16. These are enhancements of the Proximity-based Services (ProSe) specified for Long Term Evolution (LTE). Four new enhancements are particularly introduced to NR sidelink transmissions as follows:
Support for unicast and groupcast transmissions are added in NR sidelink. For unicast and groupcast, the Physical Sidelink Feedback Channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Common Control Channel (PSCCH).
To achieve a high connection density, congestion control and thus the Quality-of-Service (QoS) management is supported in NR sidelink transmissions.

To enable the above enhancements, new physical channels and reference signals are introduced in NR (some are available in LTE before.):
PSSCH (Physical Sidelink Shared Channel, SL version of PDSCH): The PSSCH is transmitted by a sidelink transmitter UE, which conveys sidelink transmission data, System Information Blocks (SIBs) for Radio Resource Control (RRC) configuration, and a part of the Sidelink Control Information (SCI).
PSFCH (Physical Sidelink, SL version of PUCCH): The PSFCH is transmitted by a sidelink receiver UE for unicast and groupcast, which conveys 1 bit information over 1 Radio Block (RB) for the HARQ acknowledgement (ACK) and the negative ACK (NACK). In addition, Channel State Information (CSI) is carried in the Medium Access Control (MAC) Control Element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (SL version of DCI) to be decoded by any UE for the channel sensing purpose, including the reserved time-frequency resources for transmissions, Demodulation Reference Signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the Sidelink Synchronization Identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (e.g., UE, network node, such as eNB, gNB etc.) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured Bandwidth Part (BWP). The PSBCH conveys information related to synchronization, such as the Direct Frame Number (DFN), indication of the slot and symbol level time resources for sidelink transmissions, in-coverage indicator, etc. The SSB is transmitted periodically at every 160 ms.
DMRS, Phase Tracking-Reference Signal (PT-RS), Channel State Information Reference Signal (CSIRS): These physical reference signals supported by NR downlink/uplink transmissions are also adopted by sidelink transmissions. Similarly, the PT-RS is only applicable for FR2 transmission.

Another new feature is the two-stage SCI. This is a version of the DCI for SL. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, New Data Indicator (NDI), Redundancy Version (RV) and Hybrid Automatic Repeat Request (HARQ) process ID is sent on the PSSCH to be decoded by the receiver UE.

Similar as for ProSe in LTE, NR sidelink transmissions have the following two modes of resource allocations:
Mode 1: Sidelink resources are scheduled by a network node, such as gNB.
Mode 2: The UE autonomously selects sidelink resources from a (pre-)configured sidelink resource pool(s) based on the channel sensing mechanism.

For the in-coverage UE, a network node, such as a gNB, can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitter UE, this UE should launch the four-message exchange procedure to request sidelink resources from a network node (Scheduling Request (SR) on UL, grant, Buffer Status Report (BSR) on UL, grant for data on SL sent to UE). During the resource request procedure, a network node, such as a gNB, may allocate a Sidelink Radio Network Temporary Identifier (SL-RNTI) to the transmitter UE. If this sidelink resource request is granted by a network node, such as a gNB, then the gNB indicates the resource allocation for the PSCCH and the PSSCH in the DCI conveyed by PDCCH with Cyclic Redundancy Check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a network node, such as a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a network node, such as a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

Layer 2 (L2) UE-to-Network (U2N) relay

In Clause 6.7 of the 3GPP TR 23.752 V2.0.0, an L2 based U2N relay is described, which is incorporated herein in its entirety by reference.

The protocol architecture supporting an L2 U2N Relay UE is provided.

The L2 U2N Relay UE provides forwarding functionality that can relay any type of traffic over the PC5 link.

The L2 U2N Relay UE provides the functionality to support connectivity to the 5GS for Remote UEs. A UE is considered to be a Remote UE if it has successfully established a PC5 link to the L2 U2N Relay UE. A Remote UE can be located within NG-RAN coverage or outside of NG-RAN coverage.

FIG. 1 schematically illustrates a user plane protocol stack for an L2 U2N Relay UE. The protocol stack is for a user plane transport related to a Protocol Data Unit (PDU) Session, including an L2 U2N Relay UE. As shown in FIG. 1, the PDU layer corresponds to the PDU carried between the Remote UE and the Data Network (DN) over the PDU session. It is important to note that the two endpoints of the PDCP link are the Remote UE and the network node, such as gNB. The relay function is performed below Packet Data Convergence Protocol (PDCP). This means that data security is ensured between the Remote UE and the gNB without exposing raw data at the U2N Relay UE. The adaptation rely layer within the L2 U2N Relay UE can differentiate between Signaling Radio Bearers (SRBs) and Data Radio Bearers (DRBs) for a particular Remote UE. The adaption relay layer is also responsible for mapping PC5 traffic to one or more DRBs of the Uu. The definition of the adaptation relay layer is under the responsibility of Radio Access Network (RAN) Work Group 2 (WG2).

FIG. 2 schematically illustrates a control plane protocol stack for an L2 U2N Relay UE. The protocol stack is for a Non-Access Stratum (NAS) connection for a Remote UE to NAS-Mobility Management (MM) and NAS-Session Management (SM) components. The NAS messages are transparently transferred between the Remote UE and 5G-Access Network (AN) over the L2 U2N Relay UE using:
PDCP end-to-end connection where the role of the L2 U2N Relay UE is to relay the PDUs over the SRB without any modifications.
N2 connection between the 5G-AN and Access and Mobility Management Function (AMF) over N2.
N3 connection between AMF and Session Management Function (SMF) over N11.

The role of the L2 U2N Relay UE is to relay the PDUs from the SRB without any modifications.

### Layer 3 (L3) U2N Relay

In Clause 6.6 of the 3GPP TR 23.752 V2.0.0, an L3 based U2N Relay is described.

FIG. 3 schematically illustrates an architecture model using a ProSe 5G U2N Relay which is an example of an L3 U2N Relay UE. As shown in FIG. 3, the ProSe 5G U2N Relay entity provides the functionality to support connectivity to the network for Remote UEs. It can be used for both public safety services and commercial services (e.g. interactive service).

A UE is considered to be a Remote UE for a certain ProSe U2N Relay if it has successfully established a PC5 link to this ProSe 5G U2N Relay. A Remote UE can be located within NG-RAN coverage or outside of NG-RAN coverage.

The ProSe 5G U2N Relay shall relay unicast traffic (uplink and downlink) between the Remote UE and the network. The ProSe U2N Relay shall provide generic function that can relay any IP traffic.

One-to-one Direct Communication is used between Remote UEs and ProSe 5G U2N Relays for unicast traffic as specified in solutions for Key Issue #2 in the 3GPP TR 23.752 V2.0.0.

FIG. 4 schematically illustrates a protocol stack for an L3 U2N Relay, e.g., a ProSe 5G U2N Relay.

Hop-by-hop security is supported in the PC5 link and the Uu link. If there are requirements beyond hop-by-hop security for protection of Remote UE's traffic, security over IP layer needs to be applied.

### SUMMARY

Embodiments of the present disclosure propose mechanisms to enable a proper path switching where there are multiple different types of candidate target paths available and different performance such as service continuity is required when switching to some types of candidate target paths while not switching to some other types of candidate target paths. The basic ideas of the present disclosure mainly consist in that:
the Remote UE indicates, in the measurement report, the type of the measured Relay UE, i.e. whether it is an L2 or an L3 Relay UE;
the network node determines the target path and performs path switching in different ways depending on the type of the selected target path;
if an L3 relay path is selected, the network node informs the Remote UE that it should switch to an L3 relay path, either with or without the information on the selected relay path;
the Remote UE performs path switching to the selected L3 relay path if the path is provided;
otherwise, the Remote UE does relay (re)selection by itself among the L3 Relay UEs and then performs path switching;
the Remote UE informs the selected L3 Relay UE during or after PC5 link establishment that it has Uu traffic to be relayed, which may trigger the relay UE to do reconfiguration required for relaying.

According to a first aspect of the present disclosure, a method at a first UE is provided. The method includes: obtaining a type of a second UE; and transmitting, to a network node, measurement report(s) of at least one second UE, wherein a measurement report of each of the at least one second UE comprises an indication of a type of the second UE.

In an exemplary embodiment, the method further includes: receiving, from the network node, a notification that the first UE should switch to a target node in a way depending on a type of the target node.

In an exemplary embodiment, the type of the target node at least includes one of:
a type of a network node, and
a type of a second UE, which at least comprises one of: a type of an L2 second UE, and a type of an L3 second UE.

In an exemplary embodiment, in a case where the first UE receives a notification that the first UE should switch to a target network node or an L2 second UE that is determined by the network node, the method further includes: switching to the target network node or the L2 second UE that is determined by the network node.

In an exemplary embodiment, in a case where the first UE receives a notification that the first UE should switch to an L3 second UE, the notification further comprises: a list of one or more L3 second UEs selected by the network node, and wherein the method further includes: selecting, from the list of the one or more selected L3 second UEs, an L3 second UE for path switching; and switching to the selected L3 second UE.

In an exemplary embodiment, in a case where the first UE receives a notification that the first UE should switch to an L3 second UE, the notification further includes: a list of one or more L3 second UEs recommended by the network node, and wherein the method further includes: selecting, from the list of the one or more recommended L3 second UEs, an L3 second UE for path switching; selecting, from one or more available L3 second UEs that are known by the first UE but not in the list, an L3 second UE for path switching, if the path switching cannot be performed successfully to any of the L3 second UEs in the list; and switching to the selected L3 second UE.

In an exemplary embodiment, in a case where the first UE receives a notification that the first UE should switch to an L3 second UE directly, or by receiving a notification that the first UE should not switch to a network node or an L2 second UE, the method further includes: selecting, from one or more available L3 second UEs that are known by the first UE, an L3 second UE for path switching; and switching to the selected L3 second UE.

In an exemplary embodiment, the indication of the type of the second UE is implemented by an indicator on the type of the second UE.

In an exemplary embodiment, in a case where the second UE is an L3 second UE, the indication of the type of the second UE is implemented by one of:
setting a UE ID of the second UE to a specific value,
not including a UE ID of the second UE in the measurement report of the second UE,
setting a serving cell ID related to the second UE to a specific value, and
not including a serving cell ID related to the second UE in the measurement report of the second UE.

In an exemplary embodiment, the notification is received in a Radio Resource Control, RRC, message, which comprises at least one of:
an RRC Release message, or
an RRC Reconfiguration message.

In an exemplary embodiment, in a case where the notification is received from the network node in the RRC Reconfiguration message, the method further includes: transmitting, to the network node, a notification whether the path switching to the selected L3 second UE is successful or not; receiving, from the network node, the RRC Release message in a case of transmitting a notification that the path switching to the selected L3 second UE is successful; and releasing, based on the received RRC Release message, at least one of:
a Uu connection between the first UE and the network node,
a sidelink logic channel that carries relayed Uu traffic, or
a PC5 link to a second UE.

In an exemplary embodiment, the method further includes: transmitting a request message for link establishment to the selected L3 second UE, if the first UE does not have a PC5 link with the selected L3 second UE, wherein the request message for link establishment comprises an establishment cause indicating that a link is established for a relaying purpose; transmitting, to the selected L3 second UE, a notification that the first UE has Uu traffic to be relayed, if the first UE has a PC5 link with the selected L3 second UE.

In an exemplary embodiment, the first UE is a Remote UE, and the second UE is a Relay UE.

According to a second aspect of the present disclosure, a method at a network node is provided. The method includes: receiving, from a first UE, measurement report(s) of at least one second UE, wherein a measurement report of each of the at least one second UE comprises an indication of a type of the second UE; determining that the first UE should switch to a target node; and performing path switching depending on a type of the target node.

In an exemplary embodiment, the type of the target node at least includes one of:
a type of a network node, and
a type of a second UE, which at least includes one of: a type of an L2 second UE, and a type of an L3 second UE.

In an exemplary embodiment, in a case where the network node determines that the first UE should switch to a target network node or an L2 second UE, said performing path switching depending on the type of the target node further includes: transmitting, to the first UE, a notification that the first node should switch to the target network node or the L2 second UE that is determined by the network node.

In an exemplary embodiment, in a case where the network node determines that the first UE should switch to an L3 second UE, said performing path switching depending on the type of the target node further includes: transmitting, to the first UE, a notification that the first UE should switch to an L3 second UE.

In an exemplary embodiment, in a case where the network node determines that the first UE should switch to an L3 second UE, the method further includes: selecting one or more L3 second UEs for the first UE, and wherein the notification transmitted to the first UE further comprises: a list of the one or more selected L3 second UEs.

In an exemplary embodiment, in a case where the network node determines that the first UE should switch to an L3 second UE, the method further includes: recommending one or more L3 second UEs for the first UE, and wherein the notification transmitted to the first UE further comprises: a list of the one or more recommended L3 second UEs.

In an exemplary embodiment, in a case where the network node determines that the first UE should switch to an L3 second UE, the notification transmitted to the first UE includes: a notification that the first UE should not switch to a network node or an L2 second UE.

In an exemplary embodiment, the indication of the type of the second UE is implemented by an indicator on the type of the second UE.

In an exemplary embodiment, in a case where the second UE is an L3 second UE, the indication of the type of the second UE is implemented by one of:
a UE ID of the second UE being set to a specific value,
no UE ID of the second UE in the measurement report of the second UE,
a serving cell ID related to the second UE being set to a specific value, and
no serving cell ID related to the second UE in the measurement report of the second UE.

In an exemplary embodiment, the notification is transmitted in a Radio Resource Control, RRC, message, which includes at least one of:
an RRC Release message, or
an RRC Reconfiguration message.

In an exemplary embodiment, in a case where the notification is transmitted by the network node in the RRC Reconfiguration message, the method further includes: receiving, from the first UE, a notification whether the path switching is successful or not; and transmitting, to the first UE, the RRC Release message in a case of receiving a notification that the path switching is successful, for triggering the first UE to release at least one of:
a Uu connection between the first UE and the network node,
a sidelink logic channel that carries relayed Uu traffic, or
a PC5 link to a second UE.

In an exemplary embodiment, the first UE is a Remote UE, and the second UE is a Relay UE.

According to a third aspect of the present disclosure, a method at a second UE is provided. The method includes: transmitting, to a first UE, information on a type of the second UE.

In an exemplary embodiment, the type of the second UE at least comprises one of:
a type of an L2 second UE, and
a type of an L3 second UE.

In an exemplary embodiment, the second UE is an L3 second UE, and the method further includes: receiving, from the first UE, a request message for link establishment, if the first UE does not have a PC5 link with the second UE, wherein the request message for link establishment comprises an establishment cause indicating that a link is established for a relaying purpose; receiving, from the first UE, a notification that the first UE has Uu traffic to be relayed, if the first UE has a PC5 link with the second UE; and performing reconfiguration required for relaying based on the received request message or notification.

In an exemplary embodiment, the first UE is a Remote UE, and the second UE is a Relay UE.

According to a fourth aspect of the present disclosure, a first UE is provided. The first UE includes: at least one processor, and at least one memory, storing instructions which, when executed on the at least one processor, cause the first UE to perform any of the methods according to the first aspect of the present disclosure.

According to a fifth aspect of the present disclosure, a network node is provided. The network node includes: at least one processor, and at least one memory, storing instructions which, when executed on the at least one processor, cause the network node to perform any of the methods according to the second aspect of the present disclosure.

According to a sixth aspect of the present disclosure, a second UE is provided. The second UE includes: at least one processor, and at least one memory, storing instructions which, when executed on the at least one processor, cause the second UE to perform any of the methods according to the third aspect of the present disclosure.

According to a seventh aspect of the present disclosure, a computer readable storage medium is provided. The computer readable storage medium has computer program instructions stored thereon, the computer program instructions, when executed by at least one processor, causing the at least one processor to perform any of the methods according to any of the first to third aspects of the present disclosure.

According to an eighth aspect of the present disclosure, a communication system is provided.

The communication system includes a host computer including: processing circuitry configured to provide user data; and a communication interface configured to forward the user data to a cellular network for transmission to a UE. The cellular network includes a network node, a transmission point, relay node, or an UE having a radio interface and processing circuitry. The network node's processing circuitry is configured to perform any of the methods according to the second aspect of the present disclosure.

In an exemplary embodiment, the communication system can further include the network node.

In an exemplary embodiment, the communication system can further include the UE. The UE is configured to communicate with the network node.

In an exemplary embodiment, the processing circuitry of the host computer can be configured to execute a host application, thereby providing the user data. The UE can include processing circuitry configured to execute a client application associated with the host application.

According to a ninth aspect of the present disclosure, a method is provided. The method is implemented in a communication system including a host computer, a network node and a UE.

The method includes: at the host computer, providing user data; and at the host computer, initiating a transmission carrying the user data to the UE via a cellular network including the network node. The network node can perform any of the methods according to the second aspect of the present disclosure.

In an exemplary embodiment, the method further can include: at the network node, transmitting the user data.

In an exemplary embodiment, the user data can be provided at the host computer by executing a host application. The method can further include: at the UE, executing a client application associated with the host application.

According to a tenth aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform any of the methods according to the first or third aspect of the present disclosure.

In an exemplary embodiment, the communication system can further include the UE.

In an exemplary embodiment, the cellular network can further include a network node configured to communicate with the UE.

In an exemplary embodiment, the processing circuitry of the host computer can be configured to execute a host application, thereby providing the user data. The UE's processing circuitry can be configured to execute a client application associated with the host application.

According to an eleventh aspect of the present disclosure, a method is provided. The method is implemented in a communication system including a host computer, a network node and a UE.

The method includes: at the host computer, providing user data; and at the host computer, initiating a transmission carrying the user data to the UE via a cellular network including the network node. The UE can perform any of the methods according to the first or third aspect of the present disclosure.

In an exemplary embodiment, the method can further include: at the UE, receiving the user data from the network node.

According to a twelfth aspect of the present disclosure, a communication system is provided. The communication system includes a host computer including: a communication interface configured to receive user data originating from a transmission from a UE to a network node.

The UE includes a radio interface and processing circuitry. The UE's processing circuitry is configured to: perform any of the methods according to the first or third aspect of the present disclosure.

In an exemplary embodiment, the communication system can further include the UE.

In an exemplary embodiment, the communication system can further include the network node.

The network node can include a radio interface configured to communicate with the UE and a communication interface configured to forward to the host computer the user data carried by a transmission from the UE to the network node.

In an exemplary embodiment, the processing circuitry of the host computer can be configured to execute a host application. The UE's processing circuitry can be configured to execute a client application associated with the host application, thereby providing the user data.

In an exemplary embodiment, the processing circuitry of the host computer can be configured to execute a host application, thereby providing request data. The UE's processing circuitry can be configured to execute a client application associated with the host application, thereby providing the user data in response to the request data.

According to a thirteenth aspect of the present disclosure, a method is provided. The method is implemented in a communication system including a host computer, a network node and a UE.

The method includes: at the host computer, receiving user data transmitted to the network node from the UE. The UE can perform any of the methods according to the first or third aspect of the present disclosure.

In an exemplary embodiment, the method can further include: at the UE, providing the user data to the network node.

In an exemplary embodiment, the method can further include: at the UE, executing a client application, thereby providing the user data to be transmitted; and at the host computer, executing a host application associated with the client application.

In an exemplary embodiment, the method can further include: at the UE, executing a client application; and at the UE, receiving input data to the client application, the input data being provided at the host computer by executing a host application associated with the client application. The user data to be transmitted is provided by the client application in response to the input data.

According to a fourteenth aspect of the present disclosure, a communication system is provided. The communication system includes a host computer including a communication interface configured to receive user data originating from a transmission from a UE to a network node. The network node includes a radio interface and processing circuitry. The network node's processing circuitry is configured to perform any of the methods according to the second aspect of the present disclosure.

In an exemplary embodiment, the communication system can further include the network node.

In an exemplary embodiment, the communication system can further include the UE. The UE can be configured to communicate with the network node.

In an exemplary embodiment, the processing circuitry of the host computer can be configured to execute a host application; the UE can be configured to execute a client application associated with the host application, thereby providing the user data to be received by the host computer.

According to a fifteenth aspect of the present disclosure, a method is provided. The method is implemented in a communication system including a host computer, a network node and a UE. The method includes: at the host computer, receiving, from the network node, user data originating from a transmission which the network node has received from the UE. The network node can perform any of the methods according to the second aspect of the present disclosure.

In an exemplary embodiment, the method can further include: at the network node, receiving the user data from the UE.

In an exemplary embodiment, the method can further include: at the network node, initiating a transmission of the received user data to the host computer.

With the technical solutions according to the exemplary embodiments of the present disclosure as described above, path switching may be performed properly and in a unified way where there are multiple different types of candidate target paths with different performance requirements. This is crucial especially considering there may be both L2 and L3 U2N Relay UEs in the system.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 schematically illustrates a user plane protocol stack for an L2 U2N Relay UE;

FIG. 2 schematically illustrates a control plane protocol stack for an L2 U2N Relay UE;

FIG. 3 schematically illustrates an architecture model using an L3 U2N Relay UE;

FIG. 4 schematically illustrates a protocol stack for an L3 U2N Relay UE;

FIG. 5 schematically shows a method at a first UE for path switching handling with multiple different types of candidate paths according to an exemplary embodiment of the present disclosure;

FIG. 6 schematically shows a method at a network node for path switching handling with multiple different types of candidate paths according to an exemplary embodiment of the present disclosure;

FIG. 7 schematically shows a method at a second UE for path switching handling with multiple different types of candidate paths according to an exemplary embodiment of the present disclosure;

FIG. 8 schematically shows a structural block diagram of a first UE according to an exemplary embodiment of the present disclosure;

FIG. 9 schematically shows a structural block diagram of a first UE according to another exemplary embodiment of the present disclosure;

FIG. 10 schematically shows a structural block diagram of a network node according to an exemplary embodiment of the present disclosure;

FIG. 11 schematically shows a structural block diagram of a network node according to another exemplary embodiment of the present disclosure;

FIG. 12 schematically shows a structural block diagram of a second UE according to an exemplary embodiment of the present disclosure;

FIG. 13 schematically shows a structural block diagram of a second UE according to another exemplary embodiment of the present disclosure;

FIG. 14 schematically illustrates a schematic diagram of an exemplary network architecture illustrating a communication system connected via an intermediate network to a host computer according to the principles in the present disclosure;

FIG. 15 schematically illustrates a generalized block diagram of a host computer communicating via a network node with a UE over an at least partially wireless connection according to some embodiments of the present disclosure;

FIG. 16 schematically illustrates a flowchart illustrating exemplary methods implemented in a communication system including a host computer, a network node and a UE for executing a client application at a UE according to some embodiments of the present disclosure;

FIG. 17 schematically illustrates a flowchart illustrating exemplary methods implemented in a communication system including a host computer, a network node and a UE for receiving user data at a UE according to some embodiments of the present disclosure;

FIG. 18 schematically illustrates a flowchart illustrating exemplary methods implemented in a communication system including a host computer, a network node and a UE for receiving user data from the UE at a host computer according to some embodiments of the present disclosure; and

FIG. 19 schematically illustrates a flowchart illustrating exemplary methods implemented in a communication system including a host computer, a network node and a UE for receiving user data at a host computer according to some embodiments of the present disclosure.

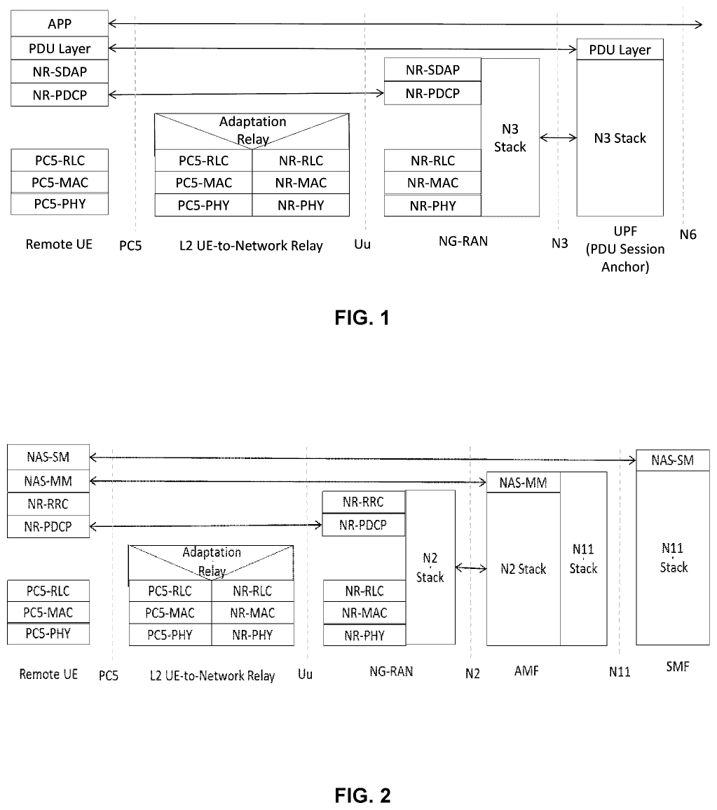

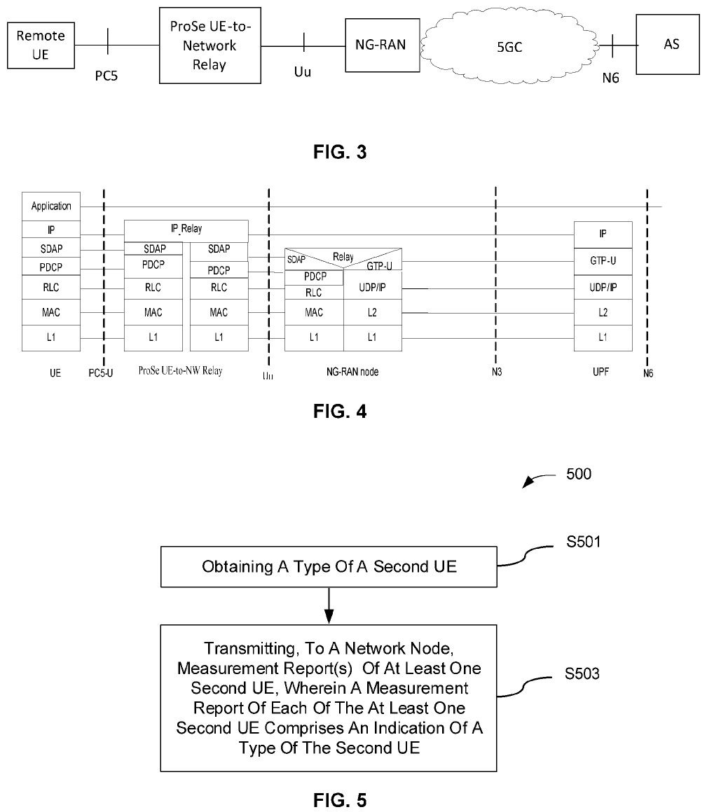

### DETAILED DESCRIPTION

In the Work Item Description (WID) on Sidelink relay as described in RP-210893 (3GPP TSG RAN Meeting *91e Electronic Meeting, Mar. 16-26, 2021, which is incorporated herein in its entirety by reference), the objective of this work item is to specify solutions to enable single-hop, sidelink-based, L2 and L3 based U2N relaying, which means both L2 and L3 U2N relaying will be supported.

For L2 U2N relay, one of the objectives is to specify Access Stratum (AS) layer mechanisms to guarantee service continuity during path switching. The Rel-15 NR handover procedure (where there is no relay) will be used as the baseline AS layer solution to guarantee service continuity, i.e. the network node (such as gNB) hands over the Remote UE to a target cell or a (L2) target Relay UE, including:
the network node determining the target cell or (L2) target Relay UE based on the measurement report(s) transmitted by the Remote UE, where the measurement report may include the (L2) Relay UE's ID and the SL link quality information;
Handover preparation type of procedure, i.e., procedure for Handover preparation, between the network node and (L2) target Relay UE (if needed);
the network node transmitting RRCReconfiguration to the Remote UE, and the Remote UE switching to the target node, which may be the target (L2) Relay UE or a target network node or the network node, and
the target node transmitting a Handover complete message, similar to the legacy procedure.

For L3 U2N relay, RAN2 will not study and introduce AS layer solution to guarantee service continuity during path switching (i.e. the Remote UE will just release the old path and (re)establish a new path via the selected Relay UE or the network node), and leave it to the upper layer (e.g. application layer) solution. This does not exclude studying some enhancements in mobility scenario for other purposes.

Clearly, the path switching procedure is different between the case where there is only L2 U2N relay (or no relay) and the case where there is (also) L3 U2N relay (either with or without L2 U2N relay). When the Remote UE is currently connected to a network node either directly or via an L2 U2N Relay UE, it may perform path switching to another direct path, or another L2 U2N relay, or a L3 U2N relay (this may require that the Remote UE supports both L2 and L3 U2N relay). Therefore, neither the path switching procedure with L2 U2N relay (or no relay) nor the path switching procedure to L3 U2N relay can be simply applied. Solutions on how to do path switching when there are multiple different types of candidate paths, i.e. direct path, L2 relay path and L3 relay path, are thus desired.

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device such as a wireless device or a radio network node.

In some embodiments, the non-limiting terms wireless device or UE are used interchangeably. The UE herein can be any type of wireless device capable of communicating with a network node or another wireless device over radio signals, such as wireless device. The UE may also be a radio communication device, target device, device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the present disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

One or more embodiments of the present disclosure propose mechanisms to enable a proper path switching where there are multiple different types of candidate target paths available and different performance such as service continuity is required when switching to some types of candidate target paths while not switching to some other types of candidate target paths. The basic ideas of the present disclosure mainly consist in that:
the Remote UE indicates, in the measurement report, the type of the measured Relay UE, i.e. whether it is an L2 or an L3 Relay UE;
the network node determines the target path and performs path switching in different ways depending on the type of the selected target path;
if an L3 relay path is selected, the network node informs the Remote UE that it should switch to an L3 relay path, either with or without the information on the selected relay path;
the Remote UE performs path switching to the selected L3 relay path if the path is provided;
otherwise, the Remote UE does relay (re)selection by itself among the L3 Relay UEs and then performs path switching;
the Remote UE informs the selected L3 Relay UE during or after PC5 link establishment that it has Uu traffic to be relayed, which may trigger the relay UE to do reconfiguration required for relaying.

Some exemplary embodiments of the present disclosure advantageously provide methods, a Remote UE, a network node, a Relay UE, and media for path switching handling with multiple different types of candidate paths, which enables path switching to be performed properly and in a unified way where there are multiple different types of candidate paths with different performance requirements. This is crucial especially considering there may be both L2 and L3 U2N Relay UEs in the system.

The exemplary embodiments of the present disclosure may be applied to not only NR Radio Access Technology (RAT) but also LTE RAT and any other RAT enabling the direct transmission between two (or more) nearby devices.

Here, a Remote UE may also be represented as a “RM UE”, which is able to transmit/receive packets from/to a network node, such as gNB, via an intermediate mobile terminal, e.g., a U2N Relay UE. Here, a Relay UE may also be represented as a “RL UE”.

The link or radio link over which the signals are transmitted between at least two UEs for Device-to-Device (D2D) operation is called herein as the Sidelink (SL). The signals transmitted between the UEs for D2D operation are called herein as SL signals. The term SL may also interchangeably be called as D2D link, Vehicle-to-Everything (V2X) link, prose link, peer-to-peer link, PC5 link etc. The SL signals may also interchangeably be called as V2X signals, D2D signals, prose signals, PC5 signals, peer-to-peer signals etc.

The Remote UE is assumed to be at least L3 relay capable, and is currently directly connected to the network node (i.e., has a direct path) or connected to the network node via an L2 Relay UE. In the latter case, the Remote UE should be both L2 relay and L3 relay capable. It should be noted that a Remote UE supporting L2 relay may support L3 relay almost for free, since almost no additional feature is required to support L3 relay if L2 relay is already supported.

Hereinafter, a method 500 at a first UE for path switching handling with multiple different types of candidate paths according to an exemplary embodiment of the present disclosure will be described with reference to FIG. 5. The first UE may be a Remote UE. As previously described, the first UE applicable to the present disclosure is assumed to be at least L3 relay capable, and currently may be directly connected to the network node or connected to the network node via an L2 Relay UE. In the latter case, the first UE may be both L2 relay and L3 relay capable.

As shown in FIG. 5, the method 500 may include at least steps S501 and S503.

In step S501, the first UE may obtain a type of a second UE. The second UE may be used as a Relay UE. The type of the second UE may at least include one of: a type of an L2 second UE, a type of an L3 second UE, a type of a U2N Relay UE, or a type of a UE-to-UE Relay UE, etc.

In an exemplary embodiment, the type of the second UE may be obtained from the second UE either via a PC5-RRC signaling or from a discovery message transmitted by the second UE.

Alternatively, specific L2 destination IDs and/or discovery type indicators may be (pre)configured to represent different types of the second UE. When the discovery message is transmitted by the second UE, such an L2 destination ID and/or discovery type indicator may be carried in SCI and/or a MAC PDU header. The first UE may obtain the type of the second UE by decoding the L2 destination ID and/or the discovery type indicator.

The first UE may skip further decoding the MAC PDU/Service Data Unit (SDU), if the type of the second UE is not what the first UE can support.

The first UE may obtain type(s) of one or more second UEs.

In step S503, the first UE may transmit, to a network node, measurement report(s) of at least one second UE. A measurement report of each of the at least one second UE may include an indication of a type of the second UE, i.e., whether the second UE is an L2 second UE or an L3 second UE, whether the second UE is a U2N Relay UE or a UE-to-UE Relay UE, etc.

For each measured second UE, the type of the second UE may be indicated explicitly or implicitly to the network node.

In an exemplary embodiment, the indication of the type of the second UE may be implemented by an explicit indicator (e.g., one bit) on the type of the second UE to explicitly indicate the type of the second UE to the network node.

Alternatively, in a case where the second UE is an L3 second UE, the indication of the type of the second UE may be implemented by one of:
setting a UE ID of the second UE to a specific value,
not including a UE ID of the second UE in the measurement report of the second UE,
setting a serving cell ID related to the second UE to a specific value, and
not including a serving cell ID related to the second UE in the measurement report of the second UE,
so as to implicitly indicate to the network node that the second UE is an L3 second UE.

Accordingly, the network node may receive, from the first UE, measurement report(s) of the at least one second UE. The network node may determine that the first UE should switch to a target node, and may transmit a corresponding notification to the first UE, notifying that the first UE should switch to a target node in a way depending on a type of the target node.

Thus, the first UE may receive, from the network node, a notification that the first UE should switch to a target node in a way depending on a type of the target node.

The type of the target node may at least include one of:
a type of a network node, and
a type of a second UE, which may at least include one of: a type of an L2 second UE, and a type of an L3 second UE.

In a case where the first UE receives a notification that the first UE should switch to a target network node or an L2 second UE that is determined by the network node, i.e., a direct path or an L2 Relay UE is selected by the network node, the method 500 may further includes: the first UE switching to the target network node or the L2 second UE that is determined by the network node. Such a path switching process is similar with the current procedure defined for L2 Relay UE or no relay as previously described, which is thus omitted here for simplicity.

In a case where the first UE receives a notification that the first UE should switch to an L3 second UE, the notification may further include: a list of one or more L3 second UEs selected by the network node. In this case, the method 500 may further include: the first UE selecting, from the list of the one or more selected L3 second UEs, an L3 second UE for path switching; and switching to the selected L3 second UE.

For example, the first UE may be notified by the network node that it should switch to an L3 second UE together with a list of one or more L3 second UEs selected by the network node. If the list contains only one selected L3 second UE, the first UE may perform path switching to the selected L3 second UE. Alternatively, if the list contains more than one selected L3 second UE, the first UE may perform path switching to e.g., any of the L3 second UEs in the list, or first perform path switching to the L3 second UE with the best SL link quality, etc. If the path switching cannot be performed successfully with any of the L3 second UE(s) in the list, the path switching is regarded failed and stopped.

In this case, the network node has a stronger control right on selection of an L3 second UE to which the first UE should switch to.

Alternatively or additionally, in a case where the first UE receives a notification that the first UE should switch to an L3 second UE, the notification may further include: a list of one or more L3 second UEs recommended by the network node. In this case, the method 500 may further include: the first UE selecting, from the list of the one or more recommended L3 second UEs, an L3 second UE for path switching; selecting, from one or more available L3 second UEs out of the list, an L3 second UE for path switching, if the path switching cannot be performed successfully to any of the L3 second UEs in the list; and switching to the selected L3 second UE.

For example, the first UE may be notified by the network node that it should switch to an L3 second UE together with a list of one or more L3 second UEs recommended by the network node. Then, the first UE may first performs path switching to the recommended L3 RL UE(s) in the list as described previously, i.e., if the list contains only one recommended L3 second UE, the first UE may perform path switching to the recommended L3 second UE. Alternatively, if the list contains more than one recommended L3 second UE, the first UE may perform path switching to e.g., any of the recommended L3 second UEs in the list, or first perform path switching to the L3 second UE with the best SL link quality, etc. If the path switching cannot be performed successfully with any of the recommended L3 second UE(s) in the list, and there are still L3 second UE(s) out of the list available, the first UE may perform RL UE (re)selection by itself among available L3 second UE(s) out of the list, and performs paths witching to the selected L3 second UE. If no suitable L3 second UE (e.g. which has sufficient SL link quality) could be found or the path switching still cannot be performed successfully with any of the suitable L3 second UE(s), the path switching is regarded failed and stopped.

In this case, the network node does not have such a stronger control right on selection of an L3 second UE to which the first UE should switch to as the network node does in the previous case.

Alternatively or additionally, in a case where the first UE receives a notification that the first UE should switch to an L3 second UE directly, or by receiving a notification that the first UE should not switch to a network node or an L2 second UE, the method 500 may further include: the first UE selecting, from one or more available L3 second UEs, an L3 second UE for path switching; and switching to the selected L3 second UE.

For example, the first UE may be notified by the network node that it should switch to an L3 second UE (which is an explicit notification) without information on which L3 second UE(s) are selected/recommended, or it should not switch to a direct path or an L2 second UE (which is an implicit notification), the first UE performs RL UE (re)selection by itself among available L3 second UE(s), and performs path switching to the selected L3 second UE. If no suitable L3 second UE (e.g. which has sufficient SL link quality) could be found or the path switching cannot be performed successfully with any of the suitable L3 second UE(s), the path switching is regarded failed and stopped.

In this case, the network node does not have any control right on selection of an L3 second UE to which the first UE should switch to. It is the first UE that makes such a selection by itself.

In an exemplary embodiment, the notification may be received in an existing RRC message, which may include at least one of: an RRC Release message (e.g., RRCRelease), or an RRC Reconfiguration message (e.g., RRCReconfiguration); or may be received in a new RRC message.

In a case where the first UE receives the notification from the network node in the RRC Release message, the first UE may first release the Uu connection with the current serving network node, and may also release the SL Logic Channel(s) (LCH(s)) that (only) carry the relayed Uu traffic, or even release the PC5 link to the current connected L2 second UE (if the first UE connects to the current serving network node via the L2 second UE), and then may perform relay (re)selection and path switching.

In a case where the first UE receives the notification from the network node in another RRC message, such as the RRC Reconfiguration message, the first UE may first perform relay (re)selection and path switching; then transmit, to the network node and optionally also the old connected L2 second UE, a notification whether the path switching to the selected L3 second UE is successful or not; in a case of transmitting a notification that the path switching to the selected L3 second UE is successful, the first UE may receive the RRC Release message from the network node, which triggers the first UE to release at least one of:
a Uu connection between the first UE and the network node,
a sidelink logic channel that carries relayed Uu traffic, or
a PC5 link to a second UE.

Then, the first UE may perform the corresponding path release.

In both of the above two cases, when the network node transmits the RRC Release message to the first UE, the network node may also transmit another RRC message, such as the RRC Reconfiguration message to the L2 second UE via which the first UE is currently connected to the network node, which may trigger the L2 second UE to release the SL LCH(s) that (only) carry the relayed Uu traffic or even release the PC5 link to the first UE.

In an exemplary embodiment, if the first UE does not have a PC5 link with the selected L3 second UE, the first UE may transmit a request message for link establishment to the selected L3 second UE. The request message for link establishment may include an establishment cause indicating that a link is established for a relaying purpose.

Alternatively, if the first UE has a PC5 link with the selected L3 second UE, the first UE may transmit, to the selected L3 second UE, a notification that the first UE has Uu traffic to be relayed.

In both of the above two cases, the L3 second UE may be triggered to do reconfiguration required for relaying, e.g. it may set up a new Uu QoS PDU session and/or set up a new or update an existing Uu QS flow/bearer for relaying RM UE's Uu traffic.

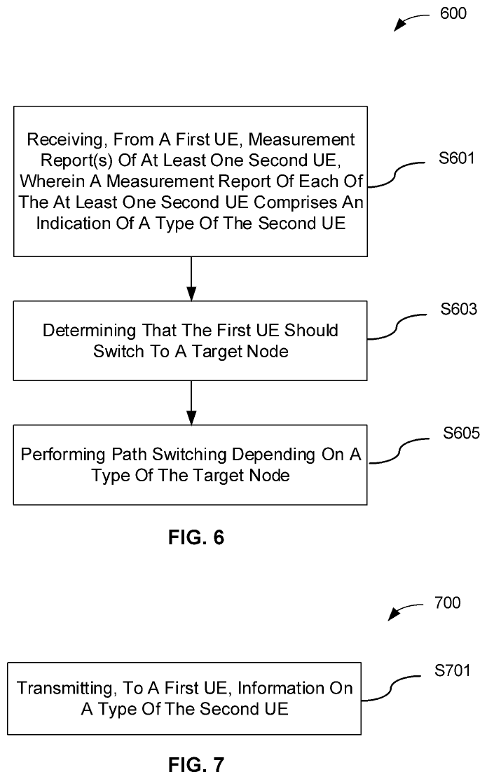

Hereinafter, a method 600 at a network node for path switching handling with multiple different types of candidate paths according to an exemplary embodiment of the present disclosure will be described with reference to FIG. 6. It should be understood that the method 600 at the network node corresponds to the method 500 at the first UE as previously described. Thus, some description of the method 600 may refer to that of method 500, and thus will be omitted for simplicity.

As shown in FIG. 6, the method 600 may include at least steps S601, S603 and S605.

In step S601, the network node may receive, from a first UE, measurement report(s) of at least one second UE, wherein a measurement report of each of the at least one second UE comprises an indication of a type of the second UE, i.e., whether the second UE is an L2 second UE or an L3 second UE, whether the second UE is a U2N Relay UE or a UE-to-UE Relay UE, etc.

For each measured second UE, the type of the second UE may be indicated explicitly or implicitly to the network node.

In an exemplary embodiment, the indication of the type of the second UE may be implemented by an explicit indicator (e.g., one bit) on the type of the second UE, so that the type of the second UE may be explicitly indicated to the network node.

Alternatively, in a case where the second UE is an L3 second UE, the indication of the type of the second UE may be implemented by one of:
a UE ID of the second UE being set to a specific value,
no UE ID of the second UE in the measurement report of the second UE,
a serving cell ID related to the second UE being set to a specific value, and
no serving cell ID related to the second UE in the measurement report of the second UE,
so that the network node may be implicitly indicated that the second UE is an L3 second UE.

In step S603, the network node may determine that the first UE should switch to a target node.

And in step S605, the network node may perform path switching depending on a type of the target node.

The type of the target node may at least include one of:
a type of a network node, and
a type of a second UE, which may at least include one of: a type of an L2 second UE, and a type of an L3 second UE.

In a case where the network node determines in step S603 that the first UE should switch to a target network node or an L2 second UE, in step S605, the network node may transmit, to the first UE, a notification that the first node should switch to the target network node or the L2 second UE that is determined by the network node. Such a path switching process is similar with the current procedure defined for L2 Relay UE or no relay, which is thus omitted here for simplicity.

In a case where the network node determines that the first UE should switch to an L3 second UE, in step S605, the network node may transmit, to the first UE, a notification that the first UE should switch to an L3 second UE.

In this case, the network node may select one or more L3 second UEs for the first UE. Accordingly, the notification transmitted to the first UE may further include: a list of the one or more selected L3 second UEs, from which the first UE selects an L3 second UE for path switching.

Alternatively or additionally, in a case where the network node determines in step S603 that the first UE should switch to an L3 second UE, the network node may recommend one or more L3 second UEs for the first UE. Accordingly, the notification transmitted to the first UE may further include: a list of the one or more recommended L3 second UEs, from or out of which the first UE selects an L3 second UE for path switching.

Alternatively or additionally, in a case where the network node determines in step S603 that the first UE should switch to an L3 second UE, the notification transmitted to the first UE may include: a notification that the first UE should not switch to a network node or an L2 second UE.

In an exemplary embodiment, the notification may be transmitted in an existing RRC message, which may include at least one of: an RRC Release message (e.g., RRCRelease), or an RRC Reconfiguration message (e.g., RRCReconfiguration); or may be transmitted in a new RRC message.

In a case where the network node transmits the notification to the first UE in the RRC Release message, the first UE may first release the Uu connection with the current serving network node, and may also release the SL Logic Channel(s) (LCH(s)) that (only) carry the relayed Uu traffic, or even release the PC5 link to the current connected L2 second UE (if the first UE connects to the current serving network node via the L2 second UE), and then may perform relay (re)selection and path switching.

In a case where t the network node transmits the notification to the first UE in another RRC message, such as the RRC Reconfiguration message, the first UE may first perform relay (re)selection and path switching. Then, the network node and optionally also the old connected L2 second UE may receive, from the first UE, a notification whether the path switching to the selected L3 second UE is successful or not; in a case of receiving a notification that the path switching to the selected L3 second UE is successful, the network node may transmit, to the first UE, the RRC Release message for triggering the first UE to release at least one of:
a Uu connection between the first UE and the network node,
a sidelink logic channel that carries relayed Uu traffic, or
a PC5 link to a second UE.

In both of the above two cases, when the network node transmits the RRC Release message to the first UE, the network node may also transmit another RRC message, such as the RRC Reconfiguration message to the L2 second UE via which the first UE is currently connected to the network node, which may trigger the L2 second UE to release the SL LCH(s) that (only) carry the relayed Uu traffic or even release the PC5 link to the first UE.

As previously described, the first UE may be a Remote UE, and the second UE may be a Relay UE.

Hereinafter, a method 700 at a second UE for path switching handling with multiple different types of candidate paths according to an exemplary embodiment of the present disclosure will be described with reference to FIG. 7. It should be understood that the method 700 at the second UE corresponds to the method 500 at the first UE and the method 600 at the network node as previously described. Thus, some description of the method 700 may refer to those of methods 500 and 600, and thus will be omitted for simplicity.

As shown in FIG. 7, the method 700 may include at least step S701, in which the second UE transmits, to a first UE, information on a type of the second UE.

In an exemplary embodiment, the second UE may provide the information on the type of the second UE to the first UE either via a PC5-RRC signaling or a discovery message transmitted to the first UE.

Alternatively, specific L2 destination IDs and/or discovery type indicators may be (pre)configured to represent different types of the second UE. When the discovery message is transmitted by the second UE, such an L2 destination ID and/or discovery type indicator may be carried in SCI and/or a MAC PDU header. The first UE may obtain the type of the second UE by decoding the L2 destination ID and/or the discovery type indicator.

In a case where the second UE is an L3 second UE, the L3 second UE may receive, from the first UE, a request message for link establishment, if the first UE does not have a PC5 link with the second UE, wherein the request message for link establishment includes an establishment cause indicating that a link is established for a relaying purpose.

If the first UE has a PC5 link with the L3 second UE, the L3 second UE may receive, from the first UE, a notification that the first UE has Uu traffic to be relayed.

In both of the above two cases, the L3 second UE may be triggered to perform reconfiguration required for relaying based on the received request message or notification, e.g. it may set up a new Uu QoS PDU session and/or set up a new or update an existing Uu QS flow/bearer for relaying RM UE's Uu traffic.

As previously described, the first UE may be a Remote UE, and the second UE may be a Relay UE.

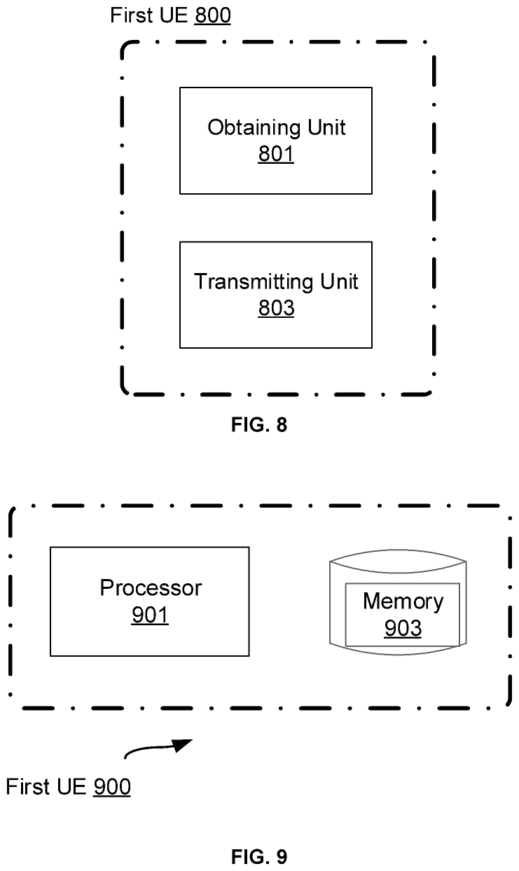

Hereinafter, a structure of a first UE according to an exemplary embodiment of the present disclosure will be described with reference to FIG. 8. FIG. 8 schematically shows a block diagram of the first UE 800 according to an exemplary embodiment of the present disclosure. The first UE 800 in FIG. 8 may perform the method 500 with reference to FIG. 5. Accordingly, some detailed description on the first UE 800 may refer to the corresponding description of the method 500 in FIG. 5, and thus will be omitted here for simplicity.

As shown in FIG. 8, the first UE 800 may include at least an obtaining unit 801 and a transmitting unit 803.

The obtaining unit 801 may be configured to obtain a type of a second UE.

The transmitting unit 803 may be configured to transmit, to a network node, measurement report(s) of at least one second UE, wherein a measurement report of each of the at least one second UE comprises an indication of a type of the second UE.

In an exemplary embodiment, the first UE 800 may further include a receiving unit (not shown), which may be configured to receive, from the network node, a notification that the first UE should switch to a target node in a way depending on a type of the target node.

In an exemplary embodiment, the type of the target node may at least include one of:
a type of a network node, and
a type of a second UE, which at least comprises one of: a type of an L2 second UE, and a type of an L3 second UE.

In an exemplary embodiment, the first UE 800 may further include a switching unit (not shown), which may be configured to: in a case where the first UE receives a notification that the first UE should switch to a target network node or an L2 second UE that is determined by the network node, switch to the target network node or the L2 second UE that is determined by the network node.

In an exemplary embodiment, in a case where the receiving unit of the first UE 800 receives a notification that the first UE should switch to an L3 second UE, the notification may further include: a list of one or more L3 second UEs selected by the network node. The first UE 800 may further include a selection unit (not shown), which may be configured to select, from the list of the one or more selected L3 second UEs, an L3 second UE for path switching. Then, the switching unit may be configured to switch to the selected L3 second UE.

In an exemplary embodiment, in a case where the receiving unit of the first UE 800 receives a notification that the first UE should switch to an L3 second UE, the notification further includes: a list of one or more L3 second UEs recommended by the network node. The selection unit may be configured to select, from the list of the one or more recommended L3 second UEs, an L3 second UE for path switching; and select, from one or more available L3 second UEs that are known by the first UE but not in the list, an L3 second UE for path switching, if the path switching cannot be performed successfully to any of the L3 second UEs in the list. Then, the switching unit may be configured to switch to the selected L3 second UE.

In an exemplary embodiment, in a case where the receiving unit of the first UE receives a notification that the first UE should switch to an L3 second UE directly, or by receiving a notification that the first UE should not switch to a network node or an L2 second UE, the selection unit may be configured to select, from one or more available L3 second UEs that are known by the first UE, an L3 second UE for path switching; and then the switching unit may be configured to switch to the selected L3 second UE.

In an exemplary embodiment, the indication of the type of the second UE is implemented by an indicator on the type of the second UE.

In an exemplary embodiment, in a case where the second UE is an L3 second UE, the indication of the type of the second UE is implemented by one of:
setting a UE ID of the second UE to a specific value,
not including a UE ID of the second UE in the measurement report of the second UE,
setting a serving cell ID related to the second UE to a specific value, and
not including a serving cell ID related to the second UE in the measurement report of the second UE.

In an exemplary embodiment, the notification is received in a Radio Resource Control, RRC, message, which comprises at least one of:
an RRC Release message, or
an RRC Reconfiguration message.

In an exemplary embodiment, in a case where the notification is received from the network node in the RRC Reconfiguration message, the transmitting unit 803 may be configured to transmit, to the network node, a notification whether the path switching to the selected L3 second UE is successful or not; and the receiving unit may be configured to receive, from the network node, the RRC Release message in a case of transmitting a notification that the path switching to the selected L3 second UE is successful. The first UE 800 may further include a releasing unit, which may be configured to release, based on the received RRC Release message, at least one of:
a Uu connection between the first UE and the network node,
a sidelink logic channel that carries relayed Uu traffic, or
a PC5 link to a second UE.

In an exemplary embodiment, the transmitting unit 803 may be configured to:
transmit a request message for link establishment to the selected L3 second UE, if the first UE does not have a PC5 link with the selected L3 second UE, wherein the request message for link establishment comprises an establishment cause indicating that a link is established for a relaying purpose;
transmit, to the selected L3 second UE, a notification that the first UE has Uu traffic to be relayed, if the first UE has a PC5 link with the selected L3 second UE.

In an exemplary embodiment, the first UE may be a Remote UE, and the second UE may be a Relay UE.

Hereinafter, a structure of a first UE according to another exemplary embodiment of the present disclosure will be described with reference to FIG. 9. FIG. 9 schematically shows a block diagram of a first UE 900 according to an exemplary embodiment of the present disclosure. The first UE 900 in FIG. 9 may perform the method 500 as described previously with reference to FIG. 5. Accordingly, some detailed description on the first UE 900 may refer to the corresponding description of the method 500 in FIG. 5, and thus will be omitted here for simplicity.

As shown in FIG. 9, the first UE 900 includes at least one processor 901 and at least one memory 903. The at least one processor 901 includes e.g., any suitable CPU (Central Processing Unit), microcontroller, DSP (Digital Signal Processor), etc., capable of executing computer program instructions. The at least one memory 903 may be any combination of a RAM (Random Access Memory) and a ROM (Read Only Memory). The at least one memory 903 may also include persistent storage, which, for example, can be any single one or combination of magnetic memory, optical memory, or solid state memory or even remotely mounted memory.

The at least one memory 903 stores instructions executable by the at least one processor 901. The instructions, when loaded from the at least one memory 903 and executed on the at least one processor 901, may cause the node 900 to perform the actions, e.g., of the procedures as described earlier in conjunction with FIG. 5, and thus will be omitted here for simplicity.

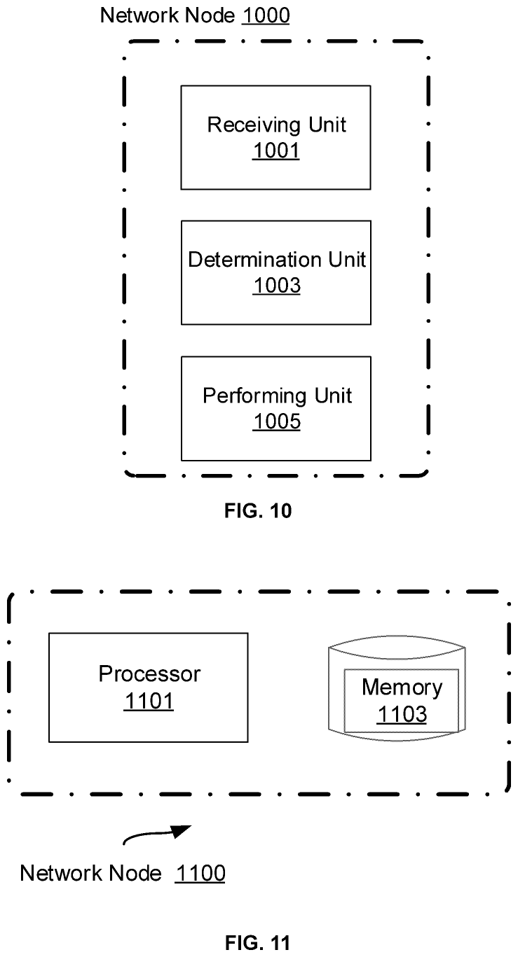

Hereinafter, a structure of a network node according to an exemplary embodiment of the present disclosure will be described with reference to FIG. 10. FIG. 10 schematically shows a block diagram of the network node 1000 according to an exemplary embodiment of the present disclosure. The network node 1000 in FIG. 10 may perform the method 600 as described previously with reference to FIG. 6. Accordingly, some detailed description on the network node 1000 may refer to the corresponding description of the method 600 in FIG. 6, and thus will be omitted here for simplicity.

As shown in FIG. 10, the network node 1000 may include at least a receiving unit 1001, a determination unit 1003 and a performing unit 1005.

The receiving unit 1001 may be configured to receive, from a first UE, measurement report(s) of at least one second UE, wherein a measurement report of each of the at least one second UE includes an indication of a type of the second UE. The determination unit 1003 may be configured to determine that the first UE should switch to a target node. The performing unit 1005 may be configured to perform path switching depending on a type of the target node.

In an exemplary embodiment, the type of the target node at least includes one of:
a type of a network node, and
a type of a second UE, which at least includes one of: a type of an L2 second UE, and a type of an L3 second UE.

In an exemplary embodiment, in a case where the determination unit 1003 determines that the first UE should switch to a target network node or an L2 second UE, the performing unit 1005 may be further configured to: transmit, to the first UE, a notification that the first node should switch to the target network node or the L2 second UE that is determined by the network node.

In an exemplary embodiment, in a case where the determination unit 1003 determines that the first UE should switch to an L3 second UE, the performing unit 1005 may be further configured to: transmit, to the first UE, a notification that the first UE should switch to an L3 second UE.

In an exemplary embodiment, the network node 1000 may further include a selection unit (not shown), which may be configured to: in a case where the determination unit 1003 determines that the first UE should switch to an L3 second UE, select one or more L3 second UEs for the first UE. In this case, the notification transmitted to the first UE may further include: a list of the one or more selected L3 second UEs.

In an exemplary embodiment, the network node 1000 may further include a recommendation unit (not shown), which may be configured to: in a case where the network node determines that the first UE should switch to an L3 second UE, recommend one or more L3 second UEs for the first UE. In this case, the notification transmitted to the first UE may further include: a list of the one or more recommended L3 second UEs.

In an exemplary embodiment, in a case where the network node determines that the first UE should switch to an L3 second UE, the notification transmitted to the first UE may include: a notification that the first UE should not switch to a network node or an L2 second UE.

In an exemplary embodiment, the indication of the type of the second UE is implemented by an indicator on the type of the second UE.

In an exemplary embodiment, in a case where the second UE is an L3 second UE, the indication of the type of the second UE is implemented by one of:
a UE ID of the second UE being set to a specific value,
no UE ID of the second UE in the measurement report of the second UE,
a serving cell ID related to the second UE being set to a specific value, and
no serving cell ID related to the second UE in the measurement report of the second UE.

In an exemplary embodiment, the notification is transmitted in a Radio Resource Control, RRC, message, which includes at least one of:
an RRC Release message, or
an RRC Reconfiguration message.

In an exemplary embodiment, in a case where the notification is transmitted by the network node in the RRC Reconfiguration message, the receiving unit 1001 may be configured to: receive, from the first UE, a notification whether the path switching is successful or not. The network node 1000 may further include a transmitting unit (not shown), which may be configured to transmit, to the first UE, the RRC Release message in a case of receiving a notification that the path switching is successful, for triggering the first UE to release at least one of:
a Uu connection between the first UE and the network node,
a sidelink logic channel that carries relayed Uu traffic, or
a PC5 link to a second UE.

In an exemplary embodiment, the first UE may be a Remote UE, and the second UE may be a Relay UE.

Hereinafter, a structure of a network node according to another exemplary embodiment of the present disclosure will be described with reference to FIG. 11. FIG. 11 schematically shows a block diagram of a network node 1100 according to an exemplary embodiment of the present disclosure. The network node 1100 in FIG. 11 may perform the method 600 as described previously with reference to FIG. 6. Accordingly, some detailed description on the network node 1100 may refer to the corresponding description of the method 600 in FIG. 6, and thus will be omitted here for simplicity.

As shown in FIG. 11, the network node 1100 includes at least one processor 1101 and at least one memory 1103. The at least one processor 1101 includes e.g., any suitable CPU (Central Processing Unit), microcontroller, DSP (Digital Signal Processor), etc., capable of executing computer program instructions. The at least one memory 1103 may be any combination of a RAM (Random Access Memory) and a ROM (Read Only Memory). The at least one memory 1103 may also include persistent storage, which, for example, can be any single one or combination of magnetic memory, optical memory, or solid state memory or even remotely mounted memory.

The at least one memory 1103 stores instructions executable by the at least one processor 1101. The instructions, when loaded from the at least one memory 1103 and executed on the at least one processor 1101, may cause the network node 1100 to perform the actions, e.g., of the procedures as described earlier respectively in conjunction with FIG. 6, and thus will be omitted here for simplicity.

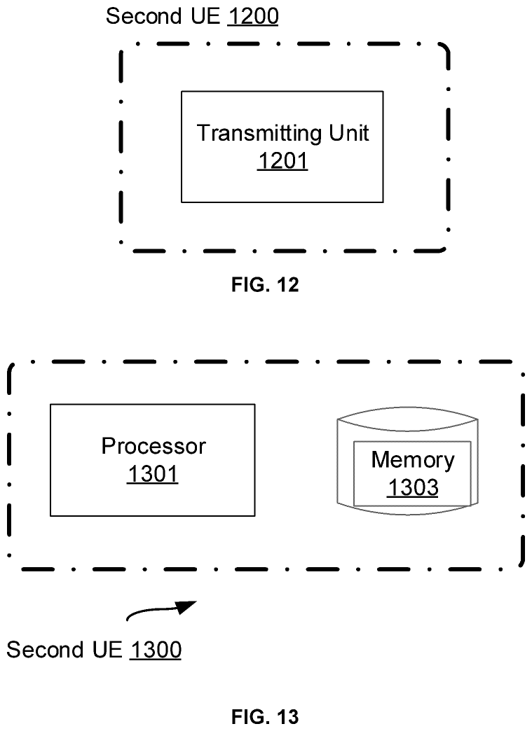

Hereinafter, a structure of a second UE according to an exemplary embodiment of the present disclosure will be described with reference to FIG. 12. FIG. 12 schematically shows a block diagram of the second UE 1200 according to an exemplary embodiment of the present disclosure. The second UE 1200 in FIG. 12 may perform the method 700 with reference to FIG. 7. Accordingly, some detailed description on the second UE 1200 may refer to the corresponding description of the method 700 in FIG. 7, and thus will be omitted here for simplicity.

As shown in FIG. 12, the second UE 1200 may include at least a transmitting unit 1201, which may be configured to transmit, to a first UE, information on a type of the second UE.

In an exemplary embodiment, the type of the second UE may at least include one of:
a type of an L2 second UE, and
a type of an L3 second UE.

In an exemplary embodiment, the second UE may be an L3 second UE. The second UE 1200 may further include a receiving unit and a configuration unit (not shown). The receiving unit may be configured to receive, from the first UE, a request message for link establishment, if the first UE does not have a PC5 link with the second UE, wherein the request message for link establishment comprises an establishment cause indicating that a link is established for a relaying purpose; and receive, from the first UE, a notification that the first UE has Uu traffic to be relayed, if the first UE has a PC5 link with the second UE. The configuration unit may be configured to perform reconfiguration required for relaying based on the received request message or notification.

In an exemplary embodiment, the first UE may be a Remote UE, and the second UE may be a Relay UE.

Hereinafter, a structure of a second UE according to another exemplary embodiment of the present disclosure will be described with reference to FIG. 13. FIG. 13 schematically shows a block diagram of a second UE 1300 according to an exemplary embodiment of the present disclosure. The second UE 1300 in FIG. 13 may perform the method 700 as described previously with reference to FIG. 7. Accordingly, some detailed description on the first UE 900 may refer to the corresponding description of the method 700 in FIG. 7, and thus will be omitted here for simplicity.

As shown in FIG. 13, the second UE 1300 includes at least one processor 1301 and at least one memory 1303. The at least one processor 1301 includes e.g., any suitable CPU (Central Processing Unit), microcontroller, DSP (Digital Signal Processor), etc., capable of executing computer program instructions. The at least one memory 1303 may be any combination of a RAM (Random Access Memory) and a ROM (Read Only Memory). The at least one memory 1303 may also include persistent storage, which, for example, can be any single one or combination of magnetic memory, optical memory, or solid state memory or even remotely mounted memory.

The at least one memory 1303 stores instructions executable by the at least one processor 1301. The instructions, when loaded from the at least one memory 1303 and executed on the at least one processor 1301, may cause the node 1300 to perform the actions, e.g., of the procedures as described earlier in conjunction with FIG. 7, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 901 causes the first UE 900 to perform the actions, e.g., of the procedures described earlier in conjunction with FIG. 5; or code/computer readable instructions, which when executed by the at least one processor 1101 causes the network node 1100 to perform the actions, e.g., of the procedures described earlier respectively in conjunction with FIG. 6; or code/computer readable instructions, which when executed by the at least one processor 1301 causes the second UE 1300 to perform the actions, e.g., of the procedures described earlier respectively in conjunction with FIG. 7.

The computer program product may be configured as a computer program code structured in computer program modules. The computer program modules could essentially perform the actions of the flow illustrated in any of FIGS. 5 to 7.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

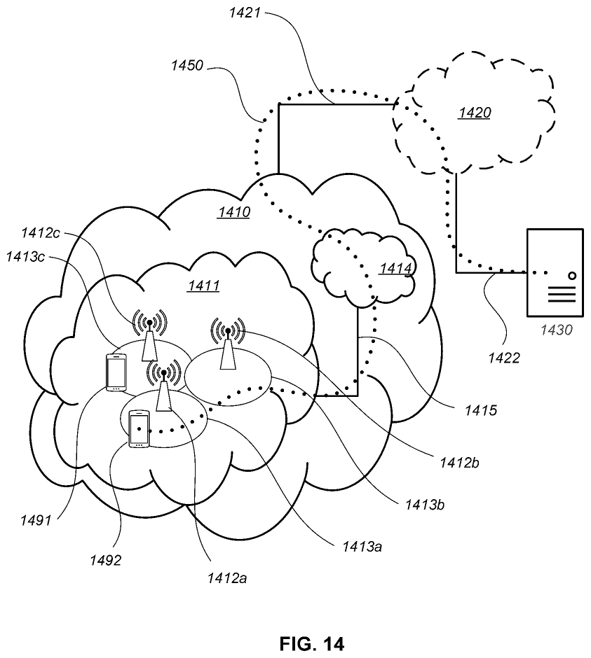

With reference to FIG. 14, in accordance with an embodiment, a communication system includes a telecommunication network 1410, such as a 3GPP-type cellular network, which comprises an access network 1411, such as a radio access network, and a core network 1414. The access network 1411 comprises a plurality of network nodes 1412a, 1412b, 1412c, such as NBs, eNBs, gNBs or other types of wireless access points, each defining a corresponding coverage area 1413a, 1413b, 1413c. Each network node 1412a, 1412b, 1412c is connectable to the core network 1414 over a wired or wireless connection 1415. A first user equipment (UE) 1491 located in coverage area 1413c is configured to wirelessly connect to, or be paged by, the corresponding network node 1412c. A second UE 1492 in coverage area 1413a is wirelessly connectable to the corresponding network node 1412a. While a plurality of UEs 1491, 1492 are illustrated in this example, the disclosed embodiments are equally applicable to a situation where a sole UE is in the coverage area or where a sole UE is connecting to the corresponding network node 1412.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system of FIG. 14 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a network node 1412 may not or need not be informed about the past routing of an incoming downlink communication with data originating from a host computer 1430 to be forwarded (e.g., handed over) to a connected UE 1491. Similarly, the network node 1412 need not be aware of the future routing of an outgoing uplink communication originating from the UE 1491 towards the host computer 1430.

The UE 1492 is configured to include at least an interpretation unit (not shown) as previously described.

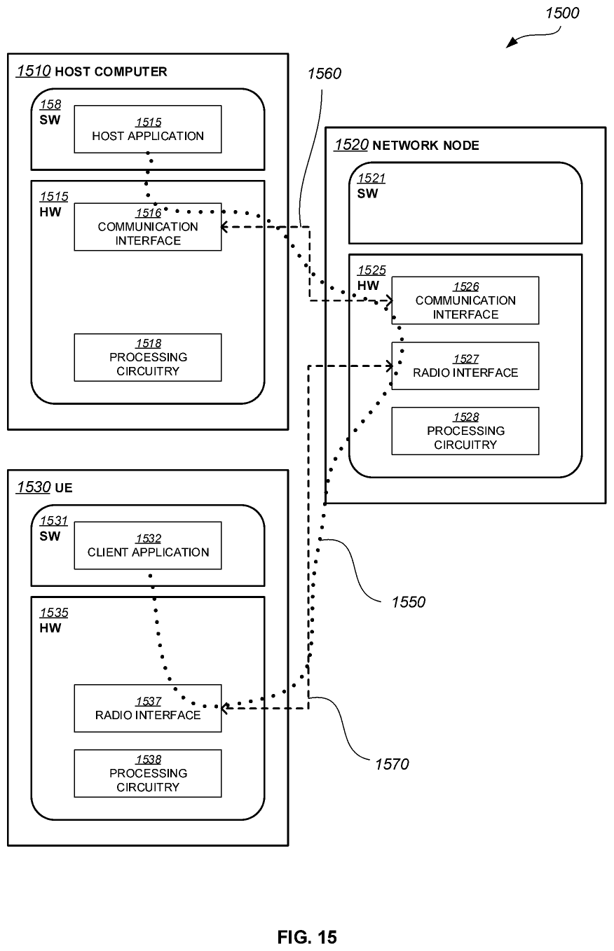

Example implementations, in accordance with an embodiment, of the UE, network node and host computer discussed in the preceding paragraphs will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 158, which is stored in or accessible by the host computer 1510 and executable by the processing circuitry 1518. The software 158 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data which is transmitted using the OTT connection 1550.

The communication system 1500 further includes a network node 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 15) served by the network node 1520. The communication interface 1526 may be configured to facilitate a connection 1560 to the host computer 1510. The connection 1560 may be direct or it may pass through a core network (not shown in FIG. 15) of the telecommunication system and/or through one or more intermediate networks outside the telecommunication system. In the embodiment shown, the hardware 1525 of the network node 1520 further includes processing circuitry 1528, which may comprise one or more programmable processors, application-specific integrated circuits, field programmable gate arrays or combinations of these (not shown) adapted to execute instructions. The network node 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a network node serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, network node 1520 and UE 1530 illustrated in FIG. 15 may be identical to the host computer 1530, one of the network nodes 1412a, 1412b, 1412c and one of the UEs 1491, 1492 of FIG. 14, respectively. This is to say, the inner workings of these entities may be as shown in FIG. 15 and independently, the surrounding network topology may be that of FIG. 14.

In FIG. 15, the OTT connection 1550 has been drawn abstractly to illustrate the communication between the host computer 1510 and the use equipment 1530 via the network node 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the network node 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may reduce PDCCH detection time and complexity and thereby provide benefits such as reduced user waiting time and reduced power consumption at the UE.

A measurement procedure may be provided for the purpose of monitoring data rate, latency and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 158 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 158, 1531 may compute or estimate the monitored quantities. The reconfiguring of the OTT connection 1550 may include message format, retransmission settings, preferred routing etc.; the reconfiguring need not affect the network node 1520, and it may be unknown or imperceptible to the network node 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 158, 1531 causes messages to be transmitted, in particular empty or ‘dummy’ messages, using the OTT connection 1550 while it monitors propagation times, errors etc.

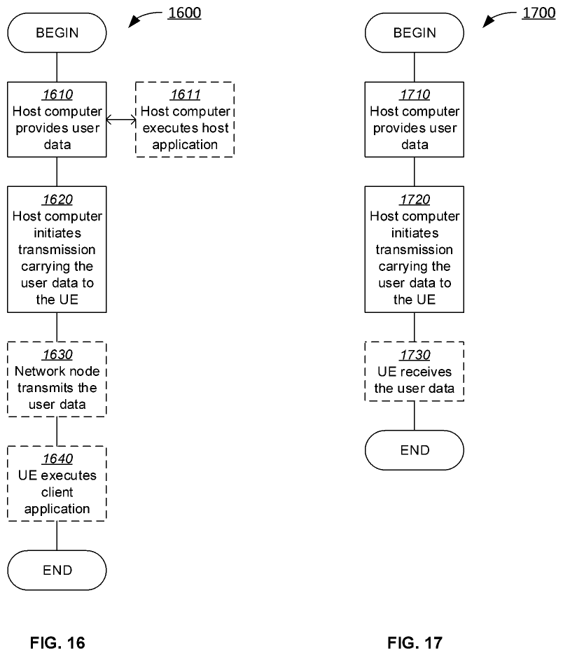

FIG. 16 is a flowchart illustrating a method 1600 implemented in a communication system, in accordance with one embodiment. The communication system includes a host computer, a network node and a UE which may be those described with reference to FIGS. 14 and 15. For simplicity of the present disclosure, only drawing references to FIG. 16 will be included in this section. In a first step 1610 of the method 1600, the host computer provides user data. In an optional substep 1611 of the first step 1610, the host computer provides the user data by executing a host application. In a second step 1620, the host computer initiates a transmission carrying the user data to the UE. In an optional third step 1630, the network node transmits to the UE the user data which was carried in the transmission that the host computer initiated, in accordance with the teachings of the embodiments described throughout this disclosure. In an optional fourth step 1640, the UE executes a client application associated with the host application executed by the host computer.

FIG. 17 is a flowchart illustrating a method 1700 implemented in a communication system, in accordance with one embodiment. The communication system includes a host computer, a network node and a UE which may be those described with reference to FIGS. 14 and 15. For simplicity of the present disclosure, only drawing references to FIG. 17 will be included in this section. In a first step 1710 of the method 1700, the host computer provides user data. In an optional substep (not shown) the host computer provides the user data by executing a host application. In a second step 1720, the host computer initiates a transmission carrying the user data to the UE. The transmission may pass via the network node, in accordance with the teachings of the embodiments described throughout this disclosure. In an optional third step 1730, the UE receives the user data carried in the transmission.

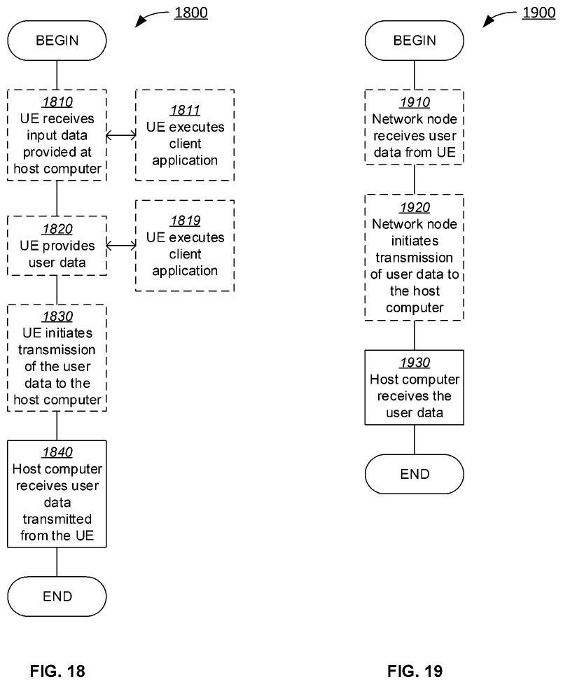

FIG. 18 is a flowchart illustrating a method 1800 implemented in a communication system, in accordance with one embodiment. The communication system includes a host computer, a network node and a UE which may be those described with reference to FIGS. 14 and 15. For simplicity of the present disclosure, only drawing references to FIG. 18 will be included in this section. In an optional first step 1810 of the method 1800, the UE receives input data provided by the host computer. Additionally or alternatively, in an optional second step 1818, the UE provides user data. In an optional substep 1821 of the second step 1818, the UE provides the user data by executing a client application. In a further optional substep 1811 of the first step 1810, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1830, transmission of the user data to the host computer. In a fourth step 1840 of the method 1800, the host computer receives the user data transmitted from the UE, in accordance with the teachings of the embodiments described throughout this disclosure.

FIG. 19 is a flowchart illustrating a method 1900 implemented in a communication system, in accordance with one embodiment. The communication system includes a host computer, a network node and a UE which may be those described with reference to FIGS. 14 and 15. For simplicity of the present disclosure, only drawing references to FIG. 19 will be included in this section. In an optional first step 1910 of the method 1900, in accordance with the teachings of the embodiments described throughout this disclosure, the network node receives user data from the UE. In an optional second step 1920, the network node initiates transmission of the received user data to the host computer. In a third step 1930, the host computer receives the user data carried in the transmission initiated by the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1.-38. (canceled)

39. A method at a Remote user equipment, UE, comprising:
obtaining a type of a Relay UE, which at least comprises one of: a type of a Layer 2, L2, Relay UE, and a type of a Layer 3, L3, Relay UE; and
transmitting, to a network node, measurement report(s) of at least one Relay UE, wherein a measurement report of each of the at least one Relay UE comprises an indication of the type of the Relay UE.

40. The method of claim 39, further comprising:
receiving, from the network node, a notification that the Remote UE should switch to a target node in a way depending on a type of the target node.

41. The method of claim 40, wherein the type of the target node at least comprises one of:
a type of a network node, and
the type of the Relay UE.

42. The method of claim 41, wherein in a case where the Remote UE receives a notification that the Remote UE should switch to a target network node or an L2 Relay UE that is determined by the network node, the method further comprises:
switching to the target network node or the L2 Relay UE that is determined by the network node.

43. The method of claim 41, wherein in a case where the Remote UE receives a notification that the Remote UE should switch to an L3 Relay UE, the notification further comprises: a list of one or more L3 Relay UEs selected by the network node, and wherein
the method further comprises:
selecting, from the list of the one or more selected L3 Relay UEs, an L3 Relay UE for path switching; and
switching to the selected L3 Relay UE.

44. The method of claim 41, wherein in a case where the Remote UE receives a notification that the Remote UE should switch to an L3 Relay UE, the notification further comprises: a list of one or more L3 Relay UEs recommended by the network node, and wherein
the method further comprises:
selecting, from the list of the one or more recommended L3 Relay UEs, an L3 Relay UE for path switching;
selecting, from one or more available L3 Relay UEs that are known by the Remote UE but not in the list, an L3 Relay UE for path switching, if the path switching cannot be performed successfully to any of the L3 Relay UEs in the list; and
switching to the selected L3 Relay UE.

45. The method of claim 41, wherein in a case where the Remote UE receives a notification that the Remote UE should switch to an L3 Relay UE directly, or by receiving a notification that the Remote UE should not switch to a network node or an L2 Relay UE, the method further comprises:
selecting, from one or more available L3 Relay UEs that are known by the Remote UE, an L3 Relay UE for path switching; and
switching to the selected L3 Relay UE.

46. The method of claim 39, wherein the indication of the type of the Relay UE is implemented by an indicator on the type of the Relay UE.

47. The method of claim 39, wherein in a case where the Relay UE is an L3 Relay UE, the indication of the type of the Relay UE is implemented by one of:
setting a UE ID of the Relay UE to a specific value,
not including a UE ID of the Relay UE in the measurement report of the Relay UE,
setting a serving cell ID related to the Relay UE to a specific value, and
not including a serving cell ID related to the Relay UE in the measurement report of the Relay UE.

48. The method of claim 40, wherein the notification is received in a Radio Resource Control, RRC, message, which comprises at least one of:
an RRC Release message, or
an RRC Reconfiguration message.

49. The method of claim 48, wherein in a case where the notification is received from the network node in the RRC Reconfiguration message, the method further comprises:
transmitting, to the network node, a notification whether the path switching to the selected L3 Relay UE is successful or not;
receiving, from the network node, the RRC Release message in a case of transmitting a notification that the path switching to the selected L3 Relay UE is successful; and
releasing, based on the received RRC Release message, at least one of:
a Uu connection between the Remote UE and the network node,
a sidelink logic channel that carries relayed Uu traffic, or
a PC5 link to a Relay UE.

50. The method of claim 43, further comprising:
transmitting a request message for link establishment to the selected L3 Relay UE, if the Remote UE does not have a PC5 link with the selected L3 Relay UE, wherein the request message for link establishment comprises an establishment cause indicating that a link is established for a relaying purpose;
transmitting, to the selected L3 Relay UE, a notification that the Remote UE has Uu traffic to be relayed, if the Remote UE has a PC5 link with the selected L3 Relay UE.

51. A method at a network node, comprising:
receiving, from a Remote User Equipment, UE, measurement report(s) of at least one Relay UE, wherein a measurement report of each of the at least one Relay UE comprises an indication of a type of the Relay UE, which at least comprises one of: a type of a Layer 2, L2, Relay UE, and a type of a Layer 3, L3, Relay UE;
determining that the Remote UE should switch to a target node; and
performing path switching depending on a type of the target node.

52. The method of claim 51, wherein the type of the target node at least comprises one of:
a type of a network node, and
the type of the Relay UE.

53. The method of claim 52, wherein in a case where the network node determines that the Remote UE should switch to a target network node or an L2 Relay UE, said performing path switching depending on the type of the target node further comprises:
transmitting, to the Remote UE, a notification that the Remote node should switch to the target network node or the L2 Relay UE that is determined by the network node.

54. The method of claim 52, wherein in a case where the network node determines that the Remote UE should switch to an L3 Relay UE, said performing path switching depending on the type of the target node further comprises:
transmitting, to the Remote UE, a notification that the Remote UE should switch to an L3 Relay UE.

55. The method of claim 52, wherein in a case where the network node determines that the Remote UE should switch to an L3 Relay UE, the method further comprises: selecting one or more L3 Relay UEs for the Remote UE, and
wherein the notification transmitted to the Remote UE further comprises: a list of the one or more selected L3 Relay UEs.

56. The method of claim 52, wherein in a case where the network node determines that the Remote UE should switch to an L3 Relay UE, the method further comprises:
recommending one or more L3 Relay UEs for the Remote UE, and
wherein the notification transmitted to the Remote UE further comprises: a list of the one or more recommended L3 Relay UEs.

57. The method of claim 52, wherein in a case where the network node determines that the Remote UE should switch to an L3 Relay UE, the notification transmitted to the Remote UE comprises: a notification that the Remote UE should not switch to a network node or an L2 Relay UE.

58. The method of claim 51, wherein the indication of the type of the Relay UE is implemented by an indicator on the type of the Relay UE.
